(19) United States
(12) Patent Application Publication
(10) Pub. No.: US 2006/0042259 A1
(43) Pub. Date: Mar. 2, 2006

(54) Combined-cycle power plant and steam thermal power plant

(76) Inventors: Shinya Marushima, Hitachinaka (JP); Mutsumi Horitsugi, Yokohama (JP); Wasao Fukumoto, Mito (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/213,724

(22) Filed: Aug. 30, 2005

(30) Foreign Application Priority Data
Aug. 31, 2004 (JP) 2004-251225

(51) Int. Cl. F02C 6/18

(52) U.S. Cl. 60/772; 60/39.182

(57) ABSTRACT

A combined-cycle power plant, a steam thermal power plant, and a method for operating the power plant, which are capable of effectively utilizing raw fuel produced from medium- or small-scaled gas fields and oil fields. Raw fuel produced from a gas field is separated into a gas component and a liquid component by a separator. The gas component is burnt in a combustor of a gas turbine, and resulting motive power is converted to electricity by a power generator. The liquid component separated by the separator is burnt in a steam generator to generate steam that is supplied to a steam turbine. Resulting motive power of the steam turbine is converted to electricity by a power generator. Since the electricity generated by the power generators is AC power, the AC power is converted by a converter to DC power that is transferred from the vicinity of the gas field to a consuming area via a cable.

### BACKGROUND OF THE INVENTION

1. Field of the Invention

The present invention relates to a combined-cycle power plant and a steam thermal power plant, which are installed near medium- or small-scaled gas fields and oil fields. More particularly, the present invention relates to a fuel line, a power generating system, and an operating method, which are used for burning raw fuel produced from gas fields and oil fields in a combined-cycle power plant or a steam thermal power plant.

2. Description of the Related Art

In view of environmental pollution in worldwide scale, regulations on exhaust gases from various engines have been urged in progress. Under such situations, natural gas is worthy of note as fuel giving less influence upon environments. Natural gas is transported from a gas field to a consuming area, as shown in FIG. 1, by a method of liquefying the natural gas with a liquefaction facility in the gas field and transporting the liquefied gas to the consuming area by land or sea, or a method of transporting the natural gas, as it is, to the consuming area through a pipeline. The pipeline includes several booster stations for boosting the pressure of natural gas to compensate for a pressure loss caused while the natural gas flows through the pipeline. The interval between the booster stations is, e.g., several tens to several hundreds kilometers. General constructions of the known gas-turbine power plants are disclosed in, e.g., Patent Document 1; JP,A 2003-166428 and Patent Reference 2; JP,A 2002-327629.

### SUMMARY OF THE INVENTION

However, progresses are not so noticeable in utilization of accompanying gases produced from medium- or small-scaled or overage gas fields and oil fields that have a difficulty in developing business by using pipelines or liquefying natural gas. In the case where those gas fields and oil fields are far away from markets and invested funds are hard to recover by the method of using pipelines or liquefying natural gas, one effective method is to generate power immediately at a source well, i.e., near a gas field and an oil field, and to supply generated electricity to the consuming area. Also, it is proved that, among various types of power generating systems, combined-cycle power generation has the highest efficiency at the present, shows high reliability and a high availability factor in long-term operation, and is superior in environmental friendliness and economy.

In many cases, raw fuel produced from the source well contains a gas component and a liquid component in a mixed state.

Burning the raw fuel as it is in the gas-liquid mixed state causes problems to be overcome in points of fuel flow control and stable combustion. If the raw fuel is burnt in the gas-liquid mixed state, the combustion temperature rises locally due to a difference in amount of heat generated per unit volume between a liquid and gas to such an extent that constructive parts may be damaged and an amount of generated nitrogen oxides may be increased, thus resulting in deterioration of both reliability and environmental friendliness. In current situations, therefore, raw fuel is required to be burnt in a gas-alone state or a liquid-alone state. One solution of meeting such a requirement is to separate raw fuel produced from the source well into a gas component and a liquid component. This solution enables the separated gas component to be used as fuel for a combined-cycle gas turbine. When using the gas component as the fuel, ingredients harmful to high-temperature constructive parts, such as heavy metals and hydrogen sulfide, must be removed from the gas component. Also, although the remaining liquid component can be refined and separated into volatile oil, naphtha, lamp oil, light oil, heavy oil, etc., it is not economically reasonable to install a refining facility for a medium- or small-scaled source well. On the other hand, because the liquid component is able to generate a very large amount of heat, effective utilization of the liquid component is desired.

It is an object of the present invention to provide a combined-cycle power plant, a steam thermal power plant, and a method for operating the power plant, which are capable of effectively utilizing raw fuel produced from medium- or small-scaled gas fields and oil fields.

To achieve the above object, the combined-cycle power plant of the present invention includes a combined-cycle power generating system comprising a gas turbine, a steam generator, and a steam turbine which are installed in the vicinity of a gas field or an oil field, wherein raw fuel produced from the gas field or the oil field is separated into gas and a liquid, and electricity is generated by using the separated gas as fuel for the gas turbine and the separated liquid as fuel for the steam generator, the generated electricity being supplied to a consuming area.

According to the present invention, it is possible to effectively utilize fuel produced from medium- or small-scaled gas fields and oil fields.

### BRIEF DESCRIPTION OF THE DRAWINGS

FIG. 1 is an illustration for explaining a known manner of utilizing natural gas;

FIG. 2 is a conceptual illustration for explaining a manner of effectively utilizing fuel produced from a gas field with a combined-cycle power plant according to one embodiment of the present invention;

FIG. 3 is a block diagram showing combined-cycle power plants according to another embodiment of the present invention;

FIG. 4 is a block diagram showing combined-cycle power plants according to still another embodiment of the present invention;

FIG. 5 is a block diagram showing a combined-cycle power plant according to still another embodiment of the present invention; and

FIG. 6 is a block diagram showing steam thermal power plants according to still another embodiment of the present invention.

### DESCRIPTION OF THE PREFERRED EMBODIMENTS

As a basic feature, a combined-cycle power plant of the present invention includes a combined-cycle power generating system comprising a gas turbine, a steam generator, and a steam turbine which are installed in the vicinity of a gas field or an oil field. Raw fuel produced from the gas field or the oil field is separated into gas and a liquid. Electricity is generated by using the separated gas as fuel for the gas turbine and the separated liquid as fuel for the steam generator. The generated electricity is supplied to a consuming area.

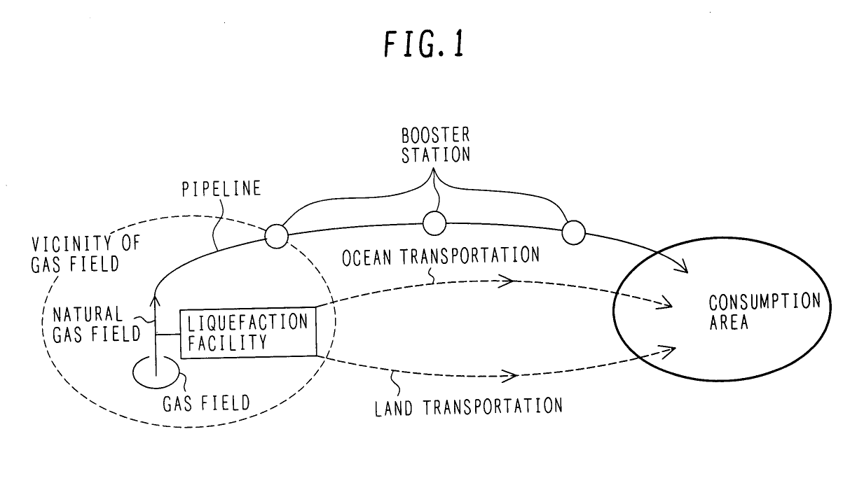

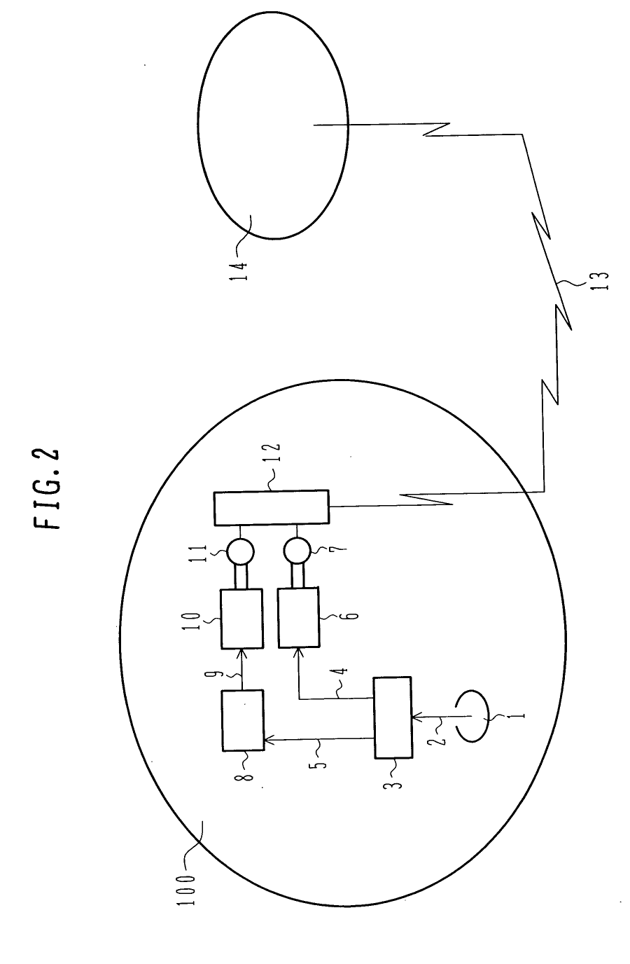

Embodiments of the present invention will be described in detail below with reference to the drawings, taking as an example the case of application to raw fuel produced from a gas field. FIG. 2 illustratively shows the construction of a combined-cycle power plant according to one embodiment, which is installed in the vicinity (indicated by 100) of a gas field 1. Raw fuel 2 produced from the gas field 1 contains a gas component and a liquid component in a mixed state. The gas component and the liquid component are both made of hydrocarbons and can be utilized as fuel. Therefore, the raw fuel 2 is separated into a gas component 4 and a liquid component 5 by a separator 3. The gas component 4 is burnt in a combustor of a gas turbine 6 to generate motive power for driving a power generator 7 for conversion to electricity. The liquid component 5 separated by the separator 3 is burnt in a steam generator 8 to generate steam 9 that is supplied to a steam turbine 10. Resulting motive power of the steam turbine 10 drives a power generator 11 for conversion to electricity. Since the electricity generated by the power generators 7, 11 is AC power, the AC power is converted by a converter 12 to DC power that is transferred to a consuming area 14 via a cable 13. The generated electricity may be consumed in an area near the gas field 1 if there is a demand for electric power in the vicinity 100 of the gas field 1. The expression “the vicinity of the gas field” means an area away from the gas field by such a distance that the gas turbine can be operated with no need of a booster, e.g., a pump, disposed midway a route for supply of natural gas from the gas field 1. Practically, the vicinity of the gas field represents an area ranging from the gas field to the first booster station of the pipeline shown in FIG. 1.

When natural gas is produced in sufficient amount from the gas field, it is advantageous from the viewpoint of economical profits to transport the produced natural gas to the consuming area by using pipelines or liquefying natural gas, as shown in FIG. 1, because such a method enables the natural gas to be transported in large amount. However, when the gas field is over aged and the outturn is already reduced, a difficulty arises in obtaining economical profits while maintaining the pipelines, the liquefaction facility, and the transportation facility that have been used so far. Accordingly, it becomes more economically advantageous to generate electricity near an overage gas field with raw fuel produced from the overage gas field and to send the generated electricity to the consuming area without employing the pipelines, the liquefaction facility, and the transportation facility that have been used so far. This method further contributes to reducing the costs necessary for repair, management and maintenance of the pipelines, the liquefaction facility, and the transportation facility. Also, the cost of a newly installed power plant can be recovered by marketing the generated electricity, and after the recovery, economical profits are expected. The power plant is preferably a gas-turbine combined-cycle power plant that requires a relatively low facility cost and has high efficiency. In the case of medium- or small-scaled gas fields, a more economical advantage can be obtained by constructing the combined-cycle power plant in the vicinity 100 of the gas field, generating electricity with the raw fuel 2 produced from the gas field, and sending the generated electricity to the consuming area 14, as shown in FIG. 2, than by constructing the pipelines or the liquefying natural gas in the vicinity 100 of the gas field, as shown in FIG. 1.

In many cases, the raw fuel 2 is produced in a gas-liquid mixed state. However, burning the raw fuel 2 as it is in the gas-liquid mixed state in a combustor of the gas turbine 6 causes problems to be overcome in points of fuel flow control and stable combustion. In current situations, therefore, the raw fuel is required to be burnt in a gas-alone state or a liquid-alone state. Similarly, combustion in the steam generator 8 also requires to be performed in a gas-alone state or a liquid-alone state. If the raw fuel is burnt in the gas-liquid mixed state, pulsations occur in a flow of the fuel and the combustion temperature rises locally due to a difference in amount of heat generated per unit volume between a liquid and gas to such an extent that constructive parts may be damaged and an amount of generated nitrogen oxides may be increased, thus resulting in deterioration of both reliability and environmental friendliness. By separating the raw fuel 2 into the gas component 4 and the liquid component 5 and utilizing the separated gas component 4 as fuel for the gas turbine 6 and the separated liquid component 5 as fuel for the steam generator 8 as in the embodiment of FIG. 2, the gas component 4 and the liquid component 5 can be separately burned in a stable state, whereby the reliability and the environmental friendliness of the combined-cycle power plant can be increased. Further, there is a possibility that the outturns of overage gas fields and medium- or small-scaled gas fields are changed to a large extent or those gas fields are exhausted up in several years. In view of such a possibility, the power plant may be constructed in units of module, such as the gas turbine, the steam turbine, and the steam generator, for easier movement of the installations, i.e., easier expansion or contraction of the power plant, depending on situations.

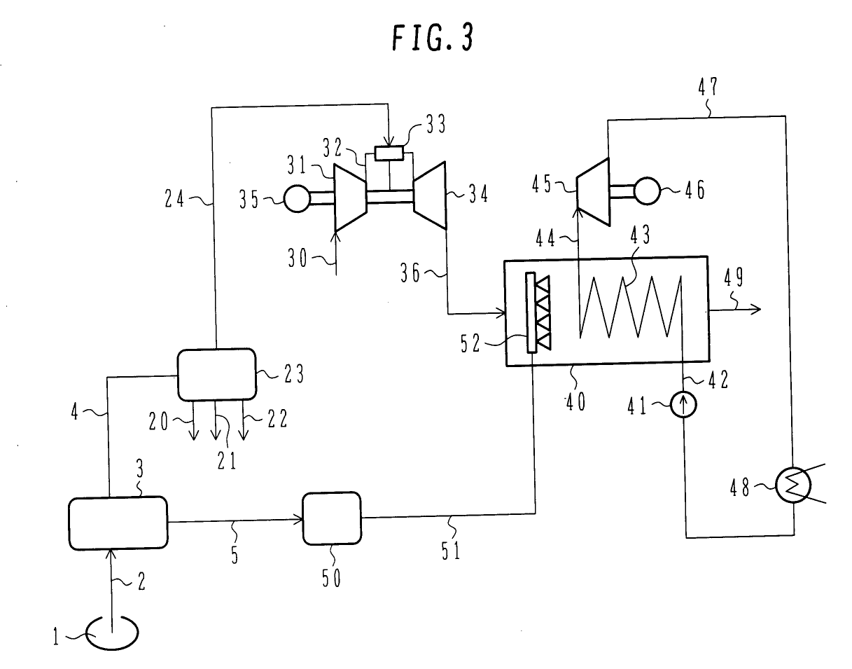

FIG. 3 shows another embodiment of the combined-cycle power plant.

Raw fuel 2 produced from a gas field 1 is separated into a gas component 4 and a liquid component 5 by a separator 3. The gas component 4 contains water 20, corrosive gases 21 such as hydrogen sulfide, and metals 22 such as vanadium. Therefore, the water 20, the corrosive gases 21, and the metals 22 are removed from the gas component 4 by a removing unit 23. Gas fuel 24 obtained from the removing unit 23 is supplied to a gas turbine. In the gas turbine, atmospheric air 30 is sucked into a compressor 31 and pressurized by the compressor 31 to produce high-temperature and high-pressure air 32. The high-temperature and high-pressure air 32 and the gas fuel 24 are burnt in a combustor 33, and combustion gases are supplied to a turbine 34 to generate motive power. The motive power generated by the gas turbine drives a power generator 35 to generate electricity. Exhaust gases 36 exhausted from the turbine 34 is supplied to an exhaust-heat recovering boiler 40. High-pressure water 42 is also supplied to the exhaust-heat recovering boiler 40 by a water feed pump 41. The high-pressure water 42 is converted to steam 44 through heat exchange between the high-pressure water 42 and the exhaust gases 36, which is performed in a heat exchanger 43 disposed inside the exhaust-heat recovering boiler 40. Exhaust gases 49 having passed through the heat exchanger 43 are discharged to the atmosphere. The steam 44 is supplied to a steam turbine 45 to generate motive power for driving a power generator 46, to thereby generate electricity. The steam 47 exiting the steam turbine 45 is converted to water by a condenser 48, and the converted water is supplied to the water feed pump 41 for circulation. The liquid component 5 obtained from the separator 3 is supplied to a tank 50. The liquid component 5 exiting the tank 50 is burnt as fuel 51 in a burner 52 disposed upstream of the heat exchanger 43. Since burning the liquid component 5 in the burner 52 increases the temperature of the exhaust gases, it is possible to increase an amount of the steam 44 generated in the exhaust-heat recovering boiler 40 and to increase an output of the steam turbine 45.

After the fuel for the gas turbine has been burnt, the resulting combustion gases pass, as turbine operating gases, through high-temperature constructive parts. Therefore, if the fuel contains a sulfur component and/or heavy metals such as vanadium, the high-temperature constructive parts of the gas turbine are corroded and damaged by those impurities. In particular, because a turbine rotor blade is subjected to centrifugal forces with rotations of the gas turbine, there is a risk that if corrosion of the blade is progressed, the blade is fallen off and excessive shaft vibrations are caused due to unbalance in turbine rotation, thus leading to shutdown of the plant. To avoid such a risk, the components adversely affecting the gas turbine are removed by the removing unit 23 to increase reliability of the gas turbine. Also, the operational life of each high-temperature part is prolonged and the interval for routine check can be set to a longer time. In addition, the probability of inevitable shutdown of the plant is reduced and operating efficiency of the plant is increased correspondingly. The liquid component 5 obtained from the separator 3 can be separated into volatile oils, naphtha, lamp oil, light oil, heavy oil, etc. However, oil refining equipment for separating the liquid component 5 requires a large cost and constructing such equipment is not advantageous from the viewpoint of economy. By burning the liquid component 5 as it is without separating the liquid component 5 like this embodiment, a cost increasing factor, e.g., the construction of the oil refining equipment, can be cut. Also, there is a possibility that the liquid component 5 contains metal-corroding components, such as sulfur and vanadium. However, the exhaust-heat recovering boiler 40 is operated under environments where the temperature is lower than that in the gas turbine and constructive parts are not subjected to centrifugal forces. Accordingly, if the corrosive components, such as sulfur and vanadium, are contained at a relatively low concentration, the liquid component 5 can be utilized as it is in the exhaust-heat recovering boiler 40. When the liquid component 5 contains the corrosive components at a relatively high concentration, a unit for removing sulfur, vanadium, etc. from the liquid component 5 may be additionally installed.

Further, since respective rotating shafts of the gas turbine and the steam turbine are of an independent multi-shaft structure, the plant can be operated in any of a mode using the gas turbine alone and a mode using the steam turbine alone. By constructing the tank 50 with a capacity capable of storing a sufficient amount of fuel, the sole operation of the steam turbine 45 can be performed even when a gas fuel supply line is shut off.

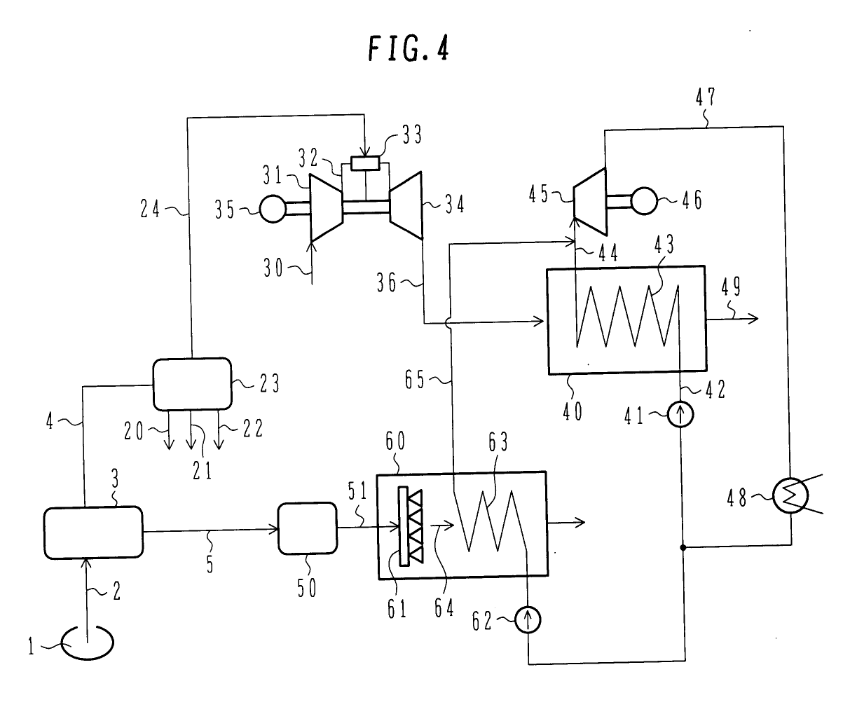

FIG. 4 shows another embodiment for utilizing the liquid component 5 in a different way. The construction of FIG. 4 differs from that of FIG. 3 in providing a separate boiler 60 for burning the liquid component 5 and generating steam, in addition to the exhaust-heat recovering boiler 40 for burning the exhaust gases 36 from the gas turbine and generating steam. The liquid component 5 separated by the separator 3 is stored in the tank 50 and burnt in a burner 61 disposed in the separate boiler 60, thereby producing combustion gases 64. The pressure of water supplied from the condenser 48 is boosted by a water feed pump 62 and supplied to a heat exchanger 63. The heat exchanger 63 produces steam 65 with heat given from the combustion gases 64. The steam 65 from the separate boiler 60 and the steam 44 from the exhaust-heat recovering boiler 40 are both supplied to the steam turbine 45 for generating motive power.

Because the corrosive components contained in the gas fuel 24 supplied to the gas turbine are removed by the removing unit 23 and held at a low concentration, corrosion of the exhaust-heat recovering boiler 40 subjected to the exhaust gases from the gas turbine is also suppressed. On the other hand, in the case of the liquid fuel 51 containing the corrosive components at a relatively high concentration, if the liquid fuel 51 is burnt in the exhaust-heat recovering boiler 40, this would raise the necessity of changing the material of the heat exchanger 43 to a highly corrosion-resistant material in order to suppress corrosion of the heat exchanger 43, and would push up the cost. By providing the separate boiler 60 dedicated for the liquid fuel 51 like this embodiment, an increase of the cost required for modifying the exhaust-heat recovering boiler 40 can be avoided. Further, because the rotating shafts of the gas turbine and the steam turbine are independent of each other, the sole operation of the steam turbine can be performed using the separate boiler 60 and the steam turbine 45. Accordingly, the power generation can be continued even during a check period of the gas turbine, and the operating efficiency can be increased correspondingly. Even when the supply of the gas fuel 24 is shut off, the sole operation of the steam turbine 45 can be performed with the liquid fuel 51, and the reliability of the power plant is increased.

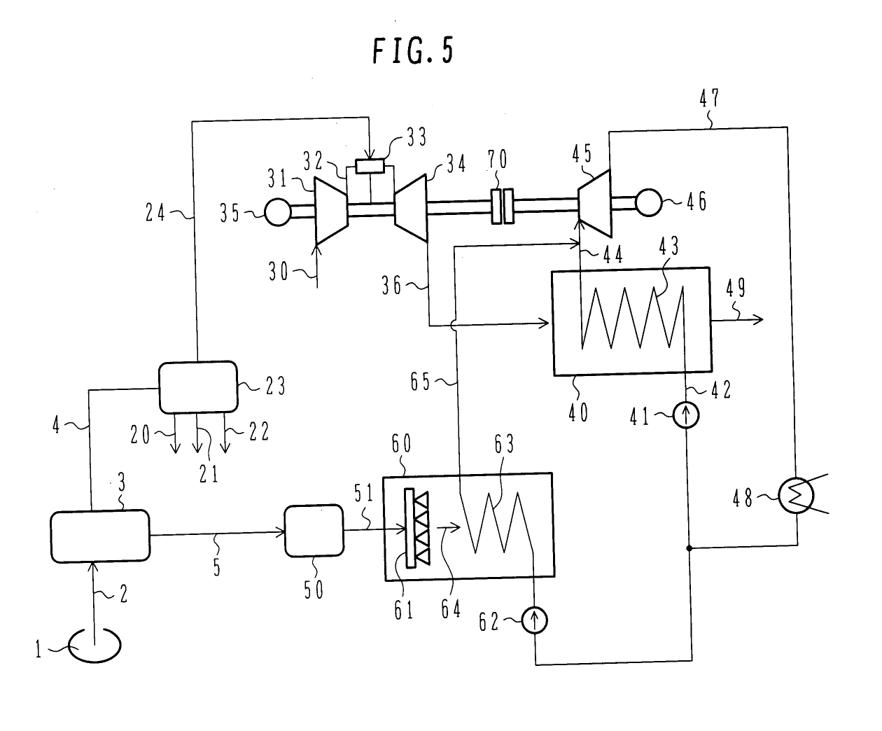

FIG. 5 shows still another embodiment of the present invention. The embodiment of FIG. 5 differs from that of FIG. 4 in coupling the rotating shaft of the gas turbine and the rotating shaft of the steam turbine through a clutch 70 in a disengageable manner. At the startup, the gas turbine is usually required to increase the rotation speed by a starting motor during a period until the combustor is ignited. By coupling the rotating shafts of the gas turbine and the steam turbine through the clutch 70, the startup operation can be performed through the steps of first generating the steam from the separate boiler 60, causing the steam turbine 45 to generate motive power, and then igniting the combustor after the rotation speed of the gas turbine has increased. Also, by starting up the gas turbine using the steam turbine, the motor for starting the gas turbine and the electric power consumed by the starting motor can be dispensed with. Accordingly, total electric power required in the plant and the installation cost can be cut. In addition, by disengaging the clutch 70, the steam turbine and the gas turbine can be each operated solely.

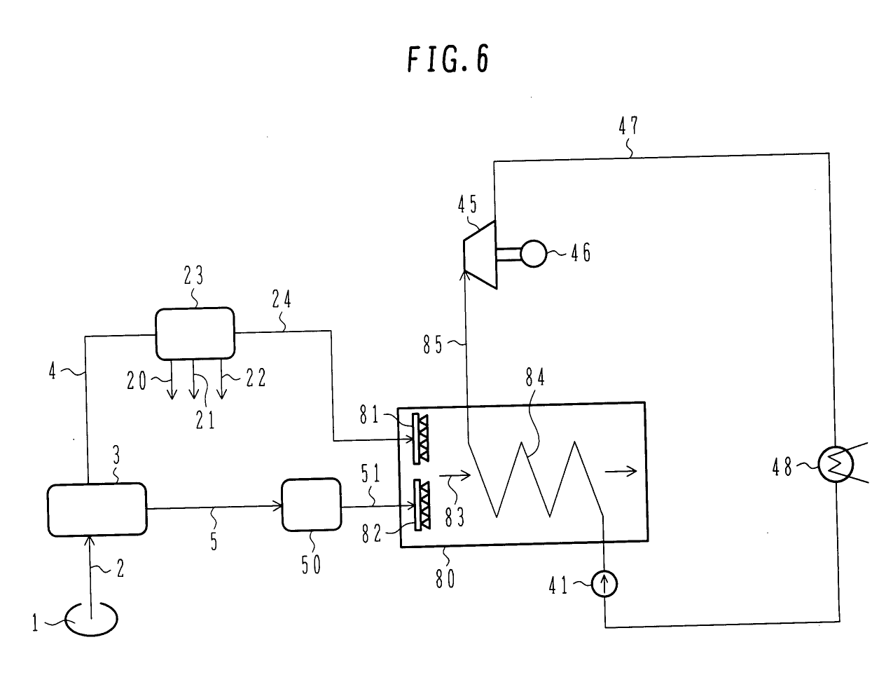

FIG. 6 shows still another embodiment utilizing steam produced with steam thermal power generation that has been performed so far with noted practical performances and high reliability. Raw fuel 2 produced from a gas field 1 is separated into a gas component 4 and a liquid component 5 by a separator 3. The gas component 4 contains water 20, corrosive gases 21 such as hydrogen sulfide, and metals 22 such as vanadium. Therefore, the water 20, the corrosive gases 21, and the metals 22 are removed from the gas component 4 by a removing unit 23. On the other hand, the liquid component 5 obtained from the separator 3 is supplied to a tank 50. Gas fuel 24 obtained from the removing unit 23 is burnt in a gas fuel burner 81 disposed in a steam boiler 80, and liquid fuel 51 stored in the tank 50 is burnt in a liquid fuel burner 82. By using combustion gases 83 obtained from both the burners 81, 82, a heat exchanger 84 disposed inside the steam boiler 80 generates steam 85 to drive a steam turbine 45 so that electricity is generated by a power generator 46. Steam 47 exiting the steam turbine 45 is converted to water by a condenser 48 and is supplied to the boiler 80 by a water feed pump 41.

With the gas fuel burner 81 and the liquid fuel burner 82 disposed independently of each other, fuel flow control is facilitated and a stable combustion state can be held. It is therefore possible to prevent constructive parts from being damaged with a local rise of the combustion temperature, and to suppress deterioration of both reliability and environmental friendliness, which may be caused with an increase in the amount of nitrogen oxides generated. When the liquid fuel contains the corrosive components at a relatively high concentration, a unit for removing sulfur, vanadium, etc. from the liquid fuel may be additionally installed.

Further, since the amount of the raw fuel and the ratio of the gas component to the liquid component differ depending on individual gas fields and oil fields, the capacities and number of the required gas turbines and steam turbines also differ depending on individual sites. In the case where the concentration of the corrosive components contained in the liquid fuel is so low as to be usable in a gas turbine and the liquid fuel is produced in larger amount than the gas fuel, not only the gas turbine dedicated for the gas fuel, but also a gas turbine dedicated for the liquid fuel may be both installed.

What is claimed is:

1. A combined-cycle power plant including a combined-cycle power generating system comprising a gas turbine, a steam generator, and a steam turbine which are installed in the vicinity of a gas field or an oil field, wherein raw fuel produced from the gas field or the oil field is separated into gas and a liquid, and electricity is generated by using the separated gas as fuel for said gas turbine and the separated liquid as fuel for said steam generator, the generated electricity being supplied to a consuming area.

2. The combined-cycle power plant according to claim 1, further comprising a unit for separating the raw fuel into gas and a liquid and removing corrosive components from the separated gas.

3. The combined-cycle power plant according to claim 1, wherein said power plant includes, as said steam generator, an exhaust-heat recovering boiler for generating steam through heat exchange with exhaust gases from said gas turbine, and after separating the raw fuel into gas and a liquid, the separated liquid is used as fuel to raise an exhaust gas temperature inside or at an inlet of said exhaust-heat recovering boiler, thereby producing steam to generate electricity.

4. The combined-cycle power plant according to claim 1, wherein said power plant includes, as said steam generator, an exhaust-heat recovering boiler for generating steam through heat exchange with exhaust gases from said gas turbine and another boiler separate from said exhaust-heat recovering boiler, and after separating the raw fuel into gas and a liquid, the separated liquid is used as fuel for said separate boiler.

5. The combined-cycle power plant according to claim 1, wherein power generators are connected respectively to a rotating shaft of said gas turbine and a rotating shaft of said steam turbine, the rotating shafts being rotatable independently of each other such that said gas turbine and said steam turbine is able to operate solely.

6. The combined-cycle power plant according to claim 1, wherein motive power obtained from said steam turbine is utilized to increase a rotation speed of said gas turbine at startup.

7. A steam thermal power plant including a thermal power generating system comprising a steam generator and a steam turbine which are installed in the vicinity of a gas field or an oil field, wherein raw fuel produced from the gas field or the oil field is separated into gas and a liquid, said steam generator has a nozzle for burning the separated gas and a nozzle for burning the separated liquid, and electricity generated by said steam turbine is supplied to a consuming area.

8. The steam thermal power plant according to claim 7, further comprising a unit for separating the raw fuel into gas and a liquid and removing corrosive components from the separated gas.

9. A method for operating a combined-cycle power plant or a steam thermal power plant installed in the vicinity of a gas field or an oil field, said method comprising the steps of supplying raw fuel produced from the gas field or the oil field to said combined-cycle power plant or said steam thermal power plant; and
generating electricity in the vicinity of the gas field or the oil field within 20 km using a power generator which has a capacity of 10,000 to 100,000 kw and is driven by motive power obtained from at least one of a gas turbine and a steam turbine.
